(19) United States
(12) Patent Application Publication
(10) Pub. No.: US 2024/0028988 A1
(43) Pub. Date: Jan. 25, 2024

(54) DATA DISTRIBUTION PLATFORM, INFORMATION PROCESSING SYSTEM, INFORMATION PROCESSING METHOD, AND RECORDING MEDIUM

(71) Applicant: NEC Corporation, Minato-ku, Tokyo (JP)

(72) Inventor: Jun Ono, Tokyo (JP)

(73) Assignee: NEC Corporation, Minato-ku, Tokyo (JP)

(21) Appl. No.: 18/039,876

(22) PCT Filed: Dec. 9, 2020
(86) PCT No.: PCT/JP2020/045802

§ 371 Date: Jun. 1, 2023

(51) Int. Cl. G06Q 10/0631; G06Q 30/0202; G06Q 50/12

(52) U.S. Cl. CPC G06Q 10/063118; G06Q 30/0202; G06Q 50/12

(57) ABSTRACT

A data distribution platform includes: employee information storage means in which the employee information of each employee is stored; store information storage means in which the predicted crowdedness level and the target crowdedness level of each restaurant are stored; restaurant extraction means for extracting, from the store information storage means, a restaurant of which the predicted crowdedness level is lower than the target crowdedness level as a restaurant to which a customer should be sent; employee extraction means for extracting, from the employee information storage means, an employee who can use the restaurant extracted by the restaurant extraction means as an employee to be induced to go to the restaurant; and output means for outputting a combination of the restaurant extracted by the restaurant extraction means and the employee who can use the restaurant as a matching result.

### TECHNICAL FIELD

The present invention relates to a data distribution platform, an information processing system, an information processing method, and a recording medium.

### BACKGROUND ART

A system where work-life balance benefits can be received at a designated tie-up store by presenting his/her employee identification card, such as his/her employee ID card, within a predetermined time period (e.g., within about two hours from the regular time for leaving work of a company or the end of the core time thereof) has been proposed (see, for example, Patent Literature 1).

For such a system, in order to keep the vacancy rate low for office building owners, the inventor considered increasing the sales of restaurant tenants and the satisfaction of corporate tenant employees.

### CITATION LIST

### Patent Literature

Patent Literature 1: Japanese Unexamined Patent Application Publication No. 2019-079107

### SUMMARY OF INVENTION

### Technical Problem

However, Patent Literature 1 does not propose anything about how to increase sales of restaurant tenants nor satisfaction of employees of corporate tenants.

In view of the above-described problem, an object of the present invention is to provide a data distribution platform, an information processing system, an information processing method, and a recording medium capable of increasing sales of restaurant tenants and satisfaction of employees of corporate tenants.

### Solution to Problem

A data distribution platform according to the present invention includes: employee information acquisition means for acquiring employee information of an employee; target crowdedness level acquisition means for acquiring a target crowdedness level of a restaurant; predicted crowdedness level calculation means for calculating a predicted crowdedness level of each restaurant; employee information storage means in which the employee information of each employee is stored; store information storage means in which the predicted crowdedness level and the target crowdedness level of each restaurant are stored; restaurant extraction means for extracting, from the store information storage means, a restaurant of which the predicted crowdedness level is lower than the target crowdedness level as a restaurant to which a customer should be sent; employee extraction means for extracting, from the employee information storage means, an employee who can use the restaurant extracted by the restaurant extraction means as an employee to be induced to go to the restaurant; and output means for outputting a combination of the restaurant extracted by the restaurant extraction means and the employee who can use the restaurant as a matching result.

An information processing system according to the present invention includes: a first information processing apparatus; and a second information processing apparatus; and a data distribution platform, in which the data distribution platform includes: employee information acquisition means for acquiring employee information of an employee transmitted from the first information processing apparatus; target crowdedness level acquisition means for acquiring a target crowdedness level of a restaurant transmitted from the second information processing apparatus; predicted crowdedness level calculation means for calculating a predicted crowdedness level of each restaurant; employee information storage means in which the employee information of each employee is stored; store information storage means in which the predicted crowdedness level and the target crowdedness level of each restaurant are stored; restaurant extraction means for extracting, from the store information storage means, a restaurant of which the predicted crowdedness level is lower than the target crowdedness level as a restaurant to which a customer should be sent; employee extraction means for extracting, from the employee information storage means, an employee who can go to the restaurant extracted by the restaurant extraction means as an employee to be induced to go to the restaurant; and output means for outputting a combination of the restaurant extracted by the restaurant extraction means and the employee extracted by the employee extraction means as a matching result.

An information processing method according to the present invention includes: an employee information acquisition step of acquiring employee information of an employee; a target crowdedness level acquisition step of acquiring a target crowdedness level of a restaurant; a predicted crowdedness level calculation step of calculating a predicted crowdedness level of each restaurant; a restaurant extraction step of extracting, from store information storage means, a restaurant of which the predicted crowdedness level is lower than the target crowdedness level as a restaurant to which a customer should be sent, the store information storage means storing therein the predicted crowdedness level and the target crowdedness level of each restaurant; an employee extraction step of extracting, from employee information storage means, an employee who can go to the restaurant extracted in the restaurant extraction step as an employee to be induced to go to the restaurant, the employee information storage means storing therein the employee information of each employee; and an output step of outputting a combination of the restaurant extracted in the restaurant extraction step and the employee extracted in the employee extraction step as a matching result.

A recording medium according to the present invention is a computer readable recording medium storing a program for causing a computer to perform: an employee information acquisition step of acquiring employee information of an employee; a target crowdedness level acquisition step of acquiring a target crowdedness level of a restaurant; a predicted crowdedness level calculation step of calculating a predicted crowdedness level of each restaurant; a restaurant extraction step of extracting, from store information storage means, a restaurant of which the predicted crowdedness level is lower than the target crowdedness level as a restaurant to which a customer should be sent, the store information storage means storing therein the predicted crowdedness level and the target crowdedness level of each restaurant; an employee extraction step of extracting, from employee information storage means, an employee who can go to the restaurant extracted in the restaurant extraction step as an employee to be induced to go to the restaurant, the employee information storage means storing therein the employee information of each employee; and an output step of outputting a combination of the restaurant extracted in the restaurant extraction step and the employee extracted in the employee extraction step as a matching result.

### Advantageous Effects of Invention

According to the present invention, it is possible to provide a data distribution platform, an information processing system, an information processing method, and a recording medium capable of increasing sales of restaurant tenants and satisfaction of employees of corporate tenants.

### BRIEF DESCRIPTION OF DRAWINGS

FIG. 1 is a schematic configuration diagram of a data distribution platform 10;

FIG. 2 is a flowchart of an example of operations performed by the data distribution platform 10;

FIG. 3 is a schematic configuration diagram of an information processing system 1;

FIG. 4 is a schematic configuration diagram of a data distribution platform 10;

FIG. 5 is an example of employee information stored in an employee information storage unit 11b;

FIG. 6 is an example of store information stored in a store information storage unit 11c;

FIG. 7 shows an example of a crowdedness level accumulated in a crowdedness level accumulation unit 11d;

FIG. 8 is a flowchart of an example of operations performed by an employee information acquisition means 12a;

FIG. 9 is a flowchart of an example of operations performed by a target crowdedness level acquisition means 12b;

FIG. 10 is a flowchart of an example of operations performed by a current crowdedness level acquisition means 12c;

FIG. 11 is a flowchart of an example of operations performed by a predicted crowdedness level calculation means 12d;

FIG. 12 is a flowchart of an example of operations performed by a restaurant extraction means 12e;

FIG. 13 is a flowchart of an example of operations performed by an employee extraction means 12f;

FIG. 14 is a flowchart of an example of operations performed by an output means 12g;

FIG. 15 is a flowchart of an example of operations performed by a coupon acquisition means 12h and a coupon providing means 12j;

FIG. 16 is a flowchart of an example of operations performed by a use record acquisition means 12k and a use record reporting means 12m;

FIG. 17 shows a configuration of a first information processing apparatus 20;

FIG. 18 shows a configuration of a second information processing apparatus 30;

FIG. 19 shows a sequence diagram of an example of operations performed by the information processing system 1; and

FIG. 20 shows a sequence diagram of an example of operations performed by the information processing system 1.

### EXAMPLE EMBODIMENT

### First Example Embodiment

A data distribution platform 10 according to a first example embodiment of the present invention will be described hereinafter with reference to the accompanying drawings. The same reference numerals (or symbols) are assigned to corresponding components throughout the drawings, and redundant descriptions are omitted.

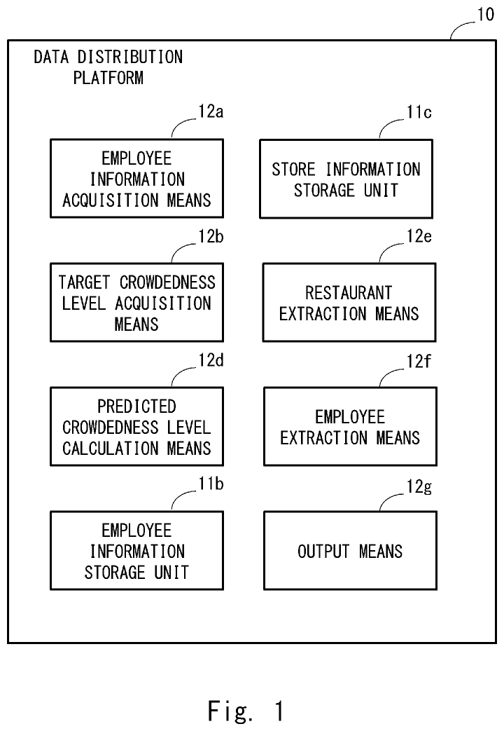

Firstly, a configuration of the data distribution platform 10 will be described with reference to FIG. 1.

FIG. 1 is a schematic configuration diagram of the data distribution platform 10.

As shown in FIG. 1, the data distribution platform 10 includes: employee information acquisition means 12a for acquiring employee information of an employee; target crowdedness level acquisition means 12b for acquiring a target crowdedness level of a restaurant; predicted crowdedness level calculation means 12d for calculating a predicted crowdedness level of each restaurant; employee information storage means 11b in which the employee information of each employee is stored; store information storage means 11c in which the predicted crowdedness level and the target crowdedness level of each restaurant are stored; restaurant extraction means 12e for extracting, from the store information storage means 11c, a restaurant of which the predicted crowdedness level is lower than the target crowdedness level as a restaurant to which a customer should be sent; employee extraction means 12f for extracting, from the employee information storage means 11b, an employee who can use the restaurant extracted by the restaurant extraction means 12e as an employee to be induced to go to the restaurant; and output means 12g for outputting a combination of the restaurant extracted by the restaurant extraction means 12e and the employee who can use the restaurant as a matching result.

Next, an example of operations performed by the data distribution platform 10 having the above-described configuration will be described.

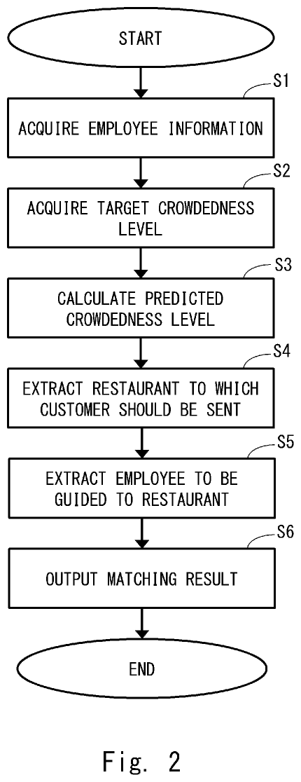

FIG. 2 is a flowchart of an example of operations performed by the data distribution platform 10.

Firstly, the employee information acquisition means 12a acquires employee information of employees (Step S1). Next, the target crowdedness level acquisition means 12b acquires a target crowdedness level of a restaurant (Step S2). Next, the predicted crowdedness level calculation means 12d calculates a predicted crowdedness level for each of the restaurants (Step S3). Next, the restaurant extraction means 12e extracts a restaurant of which the predicted crowdedness level is lower than the target crowdedness level as a restaurant to which a customer(s) should be sent (Step S4). Next, the employee extraction means 12f extracts, from the employee information storage means 11b, an employee who can use the restaurant extracted by the restaurant extraction means 12e as an employee to be induced to go to (i.e., use) the restaurant (Step S5). Next, the output means 12g outputs a combination of the restaurant extracted by the restaurant extraction means 12e and an employee who can use this restaurant as a matching result (Step S6).

As described above, according to the first example embodiment, it is possible to increase sales of restaurant tenants and satisfaction of employees of corporate tenants.

This is because the output means 12g outputs a combination of a restaurant extracted by the restaurant extraction means 12e (a restaurant of which the predicted crowdedness level is lower than the target crowdedness level) and an employee who can use this restaurant as a matching result.

### Second Example Embodiment

The data distribution platform 10 and an information processing system 1 including the data distribution platform 10 will be described hereinafter in detail as a second example embodiment according to the present invention. In the second example embodiment, an employee information storage unit is used as the employee information storage means 11b, and a store information storage unit is used as the store information storage means 11c. Further, a crowdedness level accumulation unit is used as the crowdedness level accumulation means. Hereafter, they are referred to as the employee information storage unit 11b, the store information storage unit 11c, and the crowdedness level accumulation unit 11d, respectively.

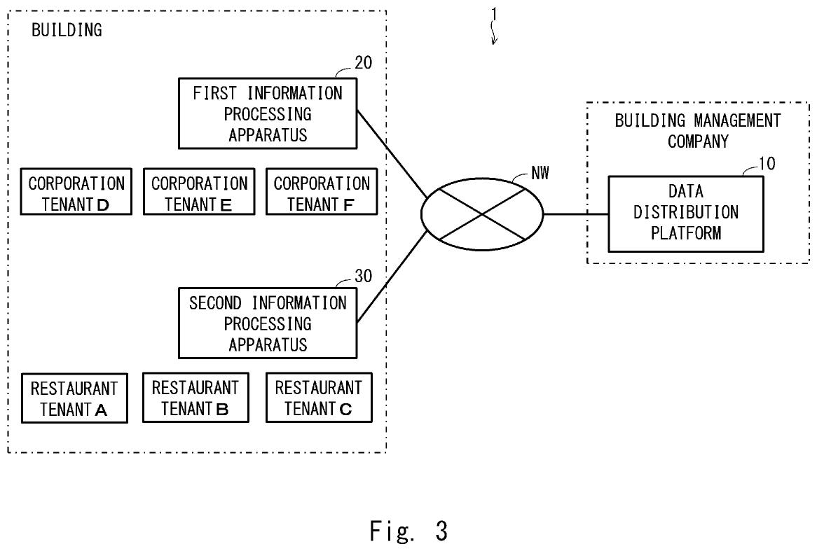

FIG. 3 is a schematic configuration diagram of the information processing system 1.

As shown in FIG. 3, the information processing system 1 includes the data distribution platform 10, a first information processing apparatus 20, and a second information processing apparatus 30. The data distribution platform 10, the first information processing apparatus 20, and the second information processing apparatus 30 are connected to each other through a network NW (e.g., the Internet), and can communicate with each other through the network NW. The data distribution platform 10 is installed, for example, in a building management company. The first and second information processing apparatuses 20 and 30 are installed in a building managed by the building management company. The building managed by the building management company are tenanted by a plurality of corporate tenants (hereafter referred to as corporations) and a plurality of restaurant tenants (hereafter referred to as restaurants).

### <Configuration Example of Data Distribution Platform 10>

Firstly, an example of a configuration of the data distribution platform 10 will be described.

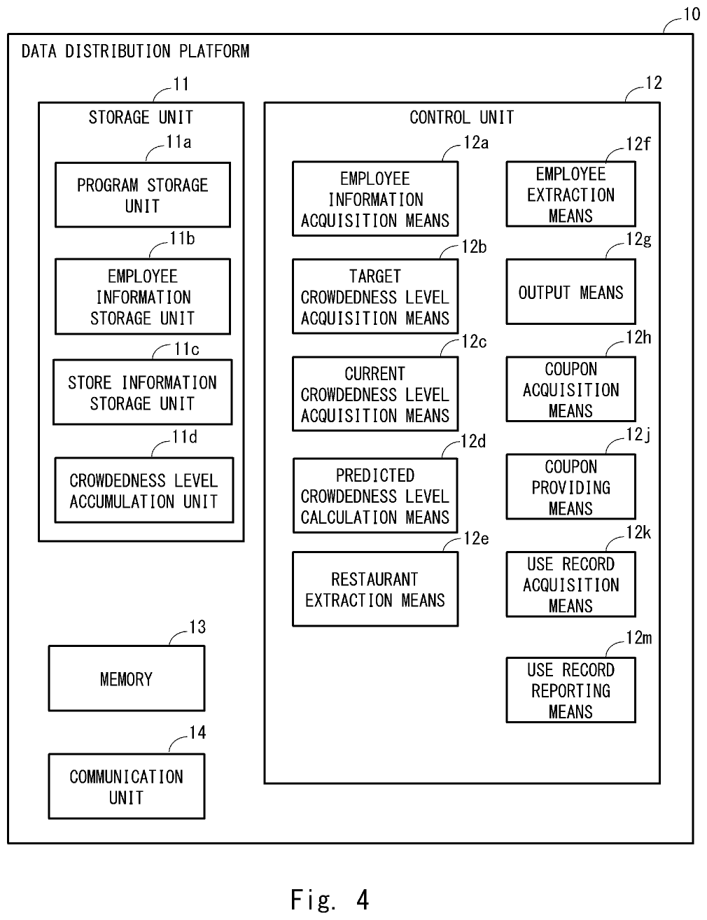

FIG. 4 is a schematic configuration diagram of the data distribution platform 10.

The data distribution platform 10 is, for example, an information processing apparatus such as a personal computer or a server apparatus. The server apparatus may be a physical server or a virtual server on the network NW. The data distribution platform 10 includes a storage unit 11, a control unit 12, a memory 13, and a communication unit 14.

The storage unit 11 is, for example, a nonvolatile storage unit such as a hard disk drive or a ROM (Read Only Memory). The storage unit 11 includes a program storage unit 11a, an employee information storage unit 11b, a store information storage unit 11c, and a crowdedness level accumulation unit 11d.

A program(s) executed by the control unit 12 (a processor) is stored in the program storage unit 11a.

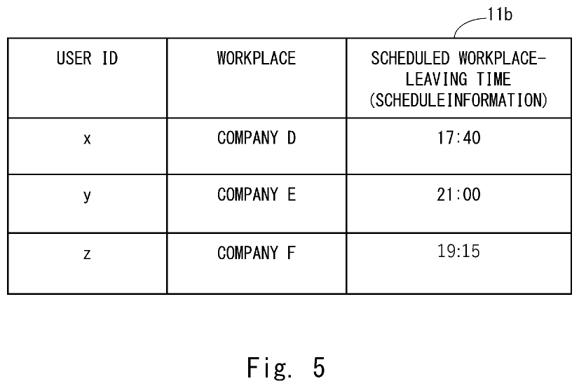

FIG. 5 is an example of employee information stored in the employee information storage unit 11b.

As shown in FIG. 5, in the employee information storage unit 11b, employee information of each employee is stored. The employee information includes a user ID, a workplace (e.g., a company), and schedule information. The user ID is a user ID assigned to an employee who works for a corporation. The user ID is not an employee number nor an email address, but is an ID that is valid only in the data distribution platform 10. The workplace is a workplace of an employee having the user ID. The schedule information is, for example, a scheduled workplace-leaving time of the employee having the user ID (i.e., a time at which the employee having the user ID is supposed to leave the workplace).

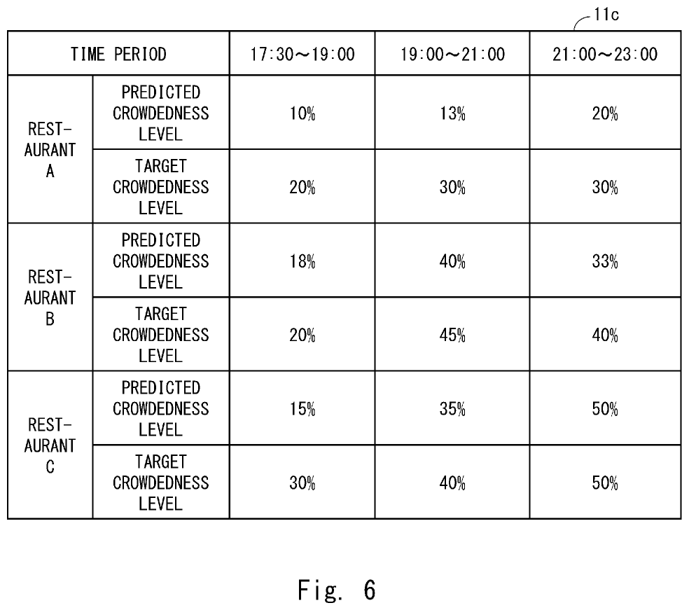

FIG. 6 is an example of store information stored in the store information storage unit 11c.

As shown in FIG. 6, store information is stored in the store information storage unit 11c. The store information includes a store name, a predicted crowdedness level, and a target crowdedness level. The predicted crowdedness level and the target crowdedness level are stored for each restaurant and for time period. The predicted crowdedness level is a predicted crowdedness level for each time period calculated by the predicted crowdedness level calculation means 12d. The target crowdedness level is a target crowdedness level entered by an employee or the like of the restaurant.

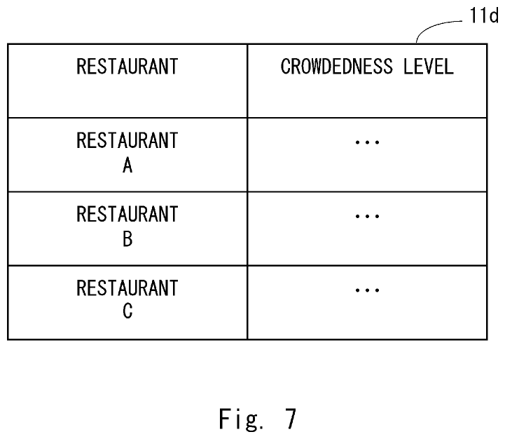

FIG. 7 is an example of crowdedness levels accumulated (i.e., stored) in the crowdedness level accumulation unit 11d.

As shown in FIG. 7, a crowdedness level is stored for each restaurant in the crowdedness level accumulation unit 11d. The crowdedness level is, for example, a crowdedness level of the restaurant for each day of the week in a certain period (e.g., in past one month) and for each time period.

The control unit 12 includes a processor (not shown). The processor is, for example, a CPU (Central Processing Unit). The processor may be one processor or may be composed of a plurality of processors. The processors function as employee information acquisition means 12a, target crowdedness level acquisition means 12b, current crowdedness level acquisition means 12c, predicted crowdedness level calculation means 12d, restaurant extraction means 12e, employee extraction means 12f, output means 12g, coupon acquisition means 12h, coupon providing means 12j, use record acquisition means 12k, and use record reporting means 12m by executing a program(s) loaded from the storage unit 11 (the program storage unit 11a) onto the memory 13 (e.g., a RAM (Random Access Memory)). Some or all of them may be implemented by hardware.

Next, an example of operations (functions) performed by each of the above-described means will be described. The below-described operations are implemented by having the control unit 12 (the processor) execute a program(s) loaded from the program storage unit 11a onto the memory 13.

<Operation Example of Employee Information Acquisition Means 12a>

The employee information acquisition means 12a acquires employee information of employees. Specifically, the employee information acquisition means 12a acquires, through the communication unit 14, employee information of an employee transmitted from a corporation (the first information processing apparatus 20) through the network NW. The employee information includes a user ID, a workplace, and schedule information. The schedule information includes, for example, a scheduled workplace-leaving time and a scheduled break time (a break start time) of the employee. An example case where the schedule information is a scheduled workplace-leaving time will be described hereinafter.

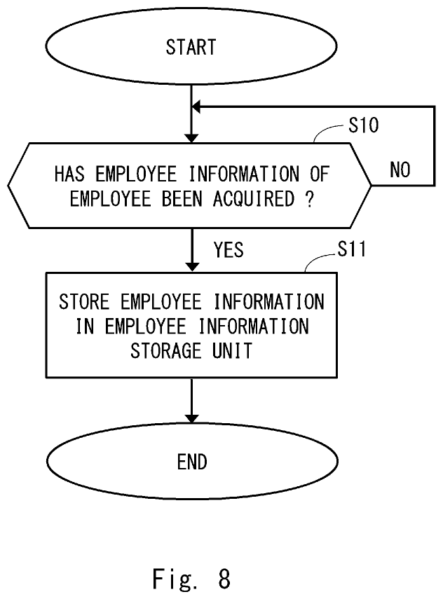

FIG. 8 is a flowchart of an example of operations performed by the employee information acquisition means 12a.

As shown in FIG. 8, when the employee information acquisition means 12a acquires employee information of an employee (Step S10: Yes), the acquired employee information is stored in the employee information storage unit 11b (see FIG. 5) (Step S11). The process in the step S11 is performed every time the employee information acquisition means 12a acquires employee information.

<Operation Example of Target Crowdedness Level Acquisition Means 12b>

The target crowdedness level acquisition means 12b acquires a target crowdedness level of a restaurant. Specifically, the target crowdedness level acquisition means 12b acquires, through communication unit 14, a target crowdedness level of a restaurant transmitted from the restaurant (i.e., from the second information processing apparatus 30) through the network NW.

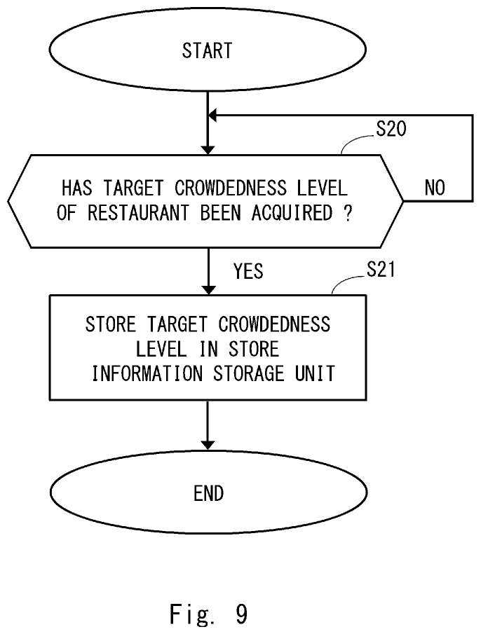

FIG. 9 is a flowchart of an example of operations performed by the target crowdedness level acquisition means 12b.

As shown in FIG. 9, when the target crowdedness level acquisition means 12b acquires a target crowdedness level of a restaurant (Step S20: Yes), the acquired target crowdedness level is stored in the store information storage unit 11c (see FIG. 6) (Step S21). The process in the step S21 is performed every time the target crowdedness level acquisition means 12b acquires a target crowdedness level.

<Operation Example of Current Crowdedness Level Acquisition Means 12c>

The current crowdedness level acquisition means 12c acquires a current crowdedness level of a restaurant. Specifically, the current crowdedness level acquisition means 12c acquires, through the communication unit 14, a current crowdedness level of a restaurant transmitted from the restaurant (i.e., from the second information processing apparatus 30) through the network NW. The current crowdedness level is a crowdedness level at the present time (expressed, for example, as [Number of currently-used seats]/[Total number of seats]).

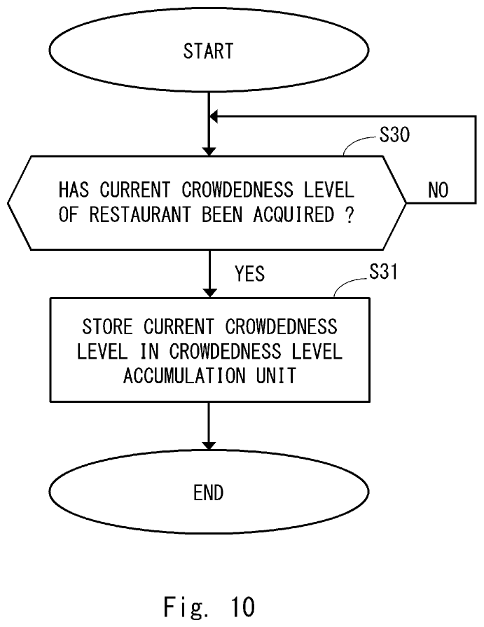

FIG. 10 is a flowchart of an example of operations performed by the current crowdedness level acquisition means 12c.

As shown in FIG. 10, when the current crowdedness level acquisition means 12c acquires a current crowdedness level of a restaurant (Step S30: Yes), the acquired current crowdedness level is accumulated (stored) in the crowdedness level accumulation unit 11d (see FIG. 7) (Step S31). The process in the step S31 is performed every time the current crowdedness level acquisition means 12c acquires a current crowdedness level.

<Operation Example of Predicted Crowdedness Calculation Means 12d>

The predicted crowdedness level calculation means 12d calculates a predicted crowdedness level of each restaurant. Specifically, the predicted crowdedness level calculation means 12d calculates a predicted crowdedness level for each time period based on the crowdedness levels accumulated (stored) in the crowdedness level accumulation unit 11d. For example, the predicted crowdedness level calculation means 12d calculates a predicted crowdedness level for each time period during business hours of the day (i.e., each of time periods from the opening of the restaurant to the closing thereof). The predicted crowdedness level can be calculated, for example, by using a known prediction method such as a regression analysis.

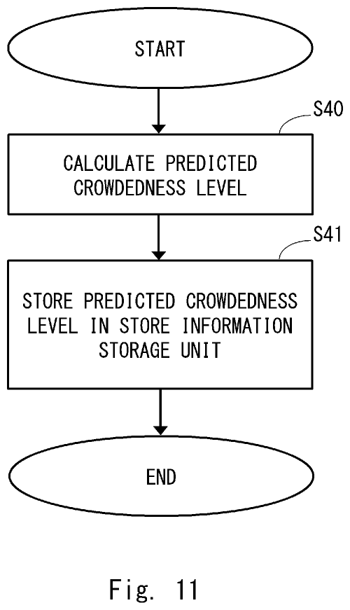

FIG. 11 is a flowchart of an example of operations performed by the predicted crowdedness level calculation means 12d.

As shown in FIG. 11, when the predicted crowdedness level calculation means 12d calculates a predicted crowdedness level of each restaurant (Step S40: Yes), the calculated predicted crowdedness level is stored in the store information storage unit 11c (see FIG. 6) (Step S41). The processes in the steps S40 and S41 are performed, for example, at regular intervals (e.g., every 30 minutes), or every time a current crowdedness level acquired by the current crowdedness level acquisition means 12c is accumulated (stored) in the crowdedness level accumulation unit 11d.

<Operation Example of Restaurant Extraction Means 12e>

The restaurant extraction means 12e extracts, from the store information storage unit 11c, a restaurant for which there is a time period during which the predicted crowdedness level is lower than the target crowdedness level as a restaurant to which a customer(s) should be sent.

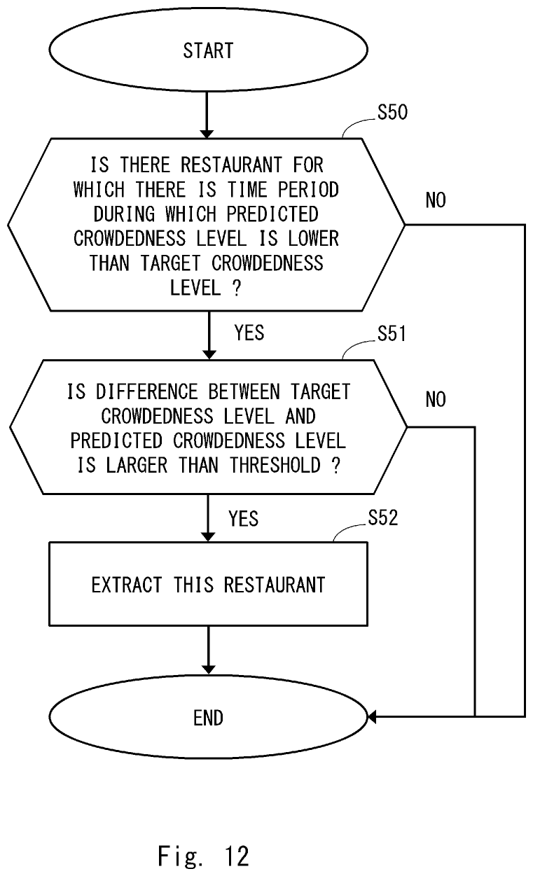

FIG. 12 is a flowchart of an example of operations performed by the restaurant extraction means 12e.

As shown in FIG. 12, the restaurant extraction means 12e determines whether or not there is a restaurant for which there is a time period during which the predicted crowdedness level is lower than the target crowdedness level (Step S50). This determination is made by using, for example, a formula “Target crowdedness level−Predicted crowdedness level≥Threshold”, or a formula “Target crowdedness level/Predicted crowdedness level≥Threshold”. As a result, when there is a restaurant for which there is a time period during which the predicted crowdedness level is lower than the target crowdedness level (Step S50: Yes), the restaurant extraction means 12e determines whether or not a difference between the target crowdedness level and the predicted crowdedness level is equal to or greater than a threshold (Step S51). As a result, when the difference between the target crowdedness level and the predicted crowdedness level is equal to or greater than the threshold (Step S51: Yes), the restaurant extraction means 12e extracts this restaurant from the store information storage unit 11c as a restaurant to which a customer(s) should be sent (Step S52).

For example, as shown in FIG. 6, as the restaurant for which there is a time period during which the predicted crowdedness level is lower than the target crowdedness level, and the difference between the target crowdedness level and the predicted crowdedness level is equal to or greater than the threshold (e.g., 15%), there are a restaurant A (a time period from 19:00 to 21:00) and a restaurant C (a time period from 17:30 to 19:00).

That is, regarding the restaurant A (the time period from 19:00 to 21:00), it is expressed as “Target crowdedness level (30%)−Predicted crowdedness level (13%)=17%≥Threshold (15%)”. Further, regarding the restaurant C (the time period from 17:30 to 19:00), it is expressed as “Target crowdedness level (30%)−Predicted crowdedness level (15%)=15%>Threshold (15%)”. In this case, the restaurant extraction means 12e extracts the restaurant A (the time period from 19:00 to 21:00) and the restaurant C (the time period from 17:30 to 19:00) as restaurants to which customers should be sent.

<Operation Example of Employee Extraction Means 12f>

The employee extraction means 12f extracts, from the employee information storage unit 11b, an employee who can use the restaurant for which there is a time period during which the predicted crowdedness level is lower than the target crowdedness level, which has been extracted by the restaurant extraction means 12e, in that time period.

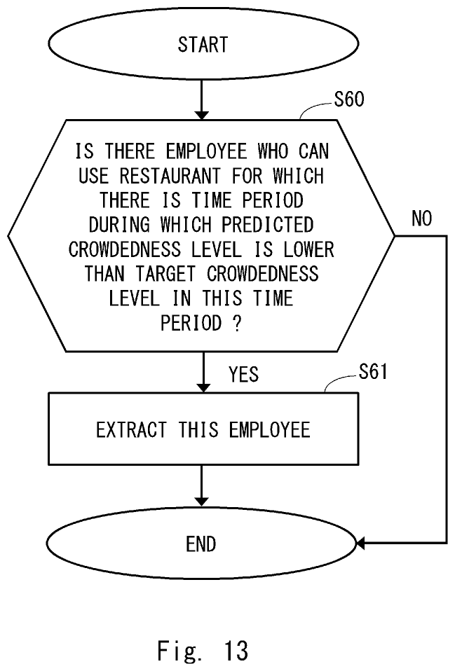

FIG. 13 is a flowchart of an example of operations performed by the employee extraction means 12f.

As shown in FIG. 13, the employee extraction means 12f determines whether or not there is an employee who can use the restaurant for which there is a time period during which the predicted crowdedness level is lower than the target crowdedness level in that time period (Step S60). As a result, when there is an employee who can use the restaurant for which there is a time period during which the predicted crowdedness level is lower than the target crowdedness level in that time period (Step S60: Yes), for example, when there is an employee whose scheduled workplace-leaving time is within or close to the time period during which the predicted crowdedness level is lower than the target crowdedness level, this employee is extracted from the employee information storage unit 11b as an employee to be induced to go to (i.e., use) the restaurant (Step S61).

For example, as shown in FIG. 5, an employee who can use the restaurant A for which there is the time period during which the predicted crowdedness level is lower than the target crowdedness level (i.e., the time period from 19:00 to 21:00) is an employee having a user ID “z” whose scheduled workplace-leaving time is within or close to this time period (the time period from 19:00 to 21:00). In this case, the employee extraction means 12f extracts the user ID “z” from the employee information storage unit 11b as an employee to be induced to go to the restaurant A.

Further, as shown in FIG. 5, an employee who can use the restaurant C in the time period during which the predicted crowdedness level is lower than the target crowdedness level (i.e., the time period from 17:30 to 19:00) is an employee having a user ID “x” whose scheduled workplace-leaving time is within or close to this time period (i.e., the time period from 17:30 to 19:00). In this case, the employee extraction means 12f extracts the user ID “x” from the employee information storage unit 11b as an employee to be induced to go to the restaurant C.

<Operation Example of Output Means 12g>

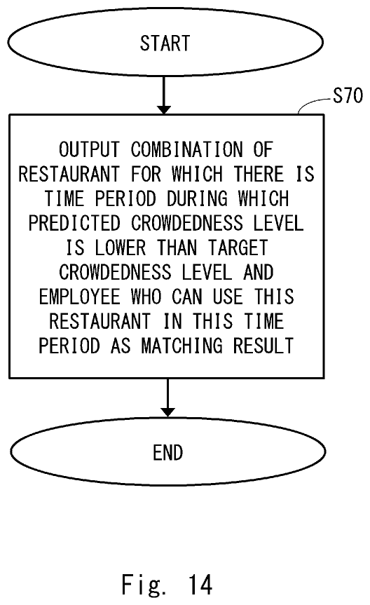

FIG. 14 is a flowchart of an example of operations performed by the output means 12g.

As shown in FIG. 14, the output means 12g outputs a combination of the restaurant having the time period during which the predicted crowdedness level is lower than the target crowdedness level, extracted by the restaurant extraction means 12e and an employee who can use this restaurant in this time period, extracted by the employee extraction means 12f as a matching result (Step S70). For example, for the restaurant having the time period during which the predicted crowdedness level is lower than the target crowdedness level, extracted by the restaurant extraction means 12e, the output means 12g outputs (e.g., transmits through the communication unit 14) the user ID of the employee who can use this restaurant in this time period, extracted by the employee extraction means 12f.

For example, for the restaurant A for which there is the time period during which the predicted crowdedness level is lower than the target crowdedness level (i.e., the time period from 19:00 to 21:00), extracted by the restaurant extraction means 12e, the output means 12g outputs (e.g., transmits through the communication unit 14) the user ID “z” of the employee who can use this restaurant A in this time period (i.e., the time period from 19:00 to 21:00), extracted by the employee extraction means 12f.

Further, for the restaurant C for which there is the time period during which the predicted crowdedness level is lower than the target crowdedness level (i.e., the time period from 17:30 to 19:00), extracted by the restaurant extraction means 12e, the output means 12g outputs (e.g., transmits through the communication unit 14) the user ID “x” of the employee who can use this restaurant C in this time period (i.e., the time period from 17:30 to 19:00), extracted by the employee extraction means 12f.

<Operation Example of Coupon Acquisition Means 12h and Coupon Providing Means 12j>

The coupon acquisition means 12h acquires, through the communication unit 14, a coupon that is transmitted through the network NW from the restaurant (the second information processing apparatus 30) that has received the matching result. Further, the coupon providing means 12j transmits, through the communication unit 14, the coupon acquired by the coupon acquisition means 12h to the corporation where the employee who has been matched to (i.e., paired with) the restaurant that has transmitted the coupon works.

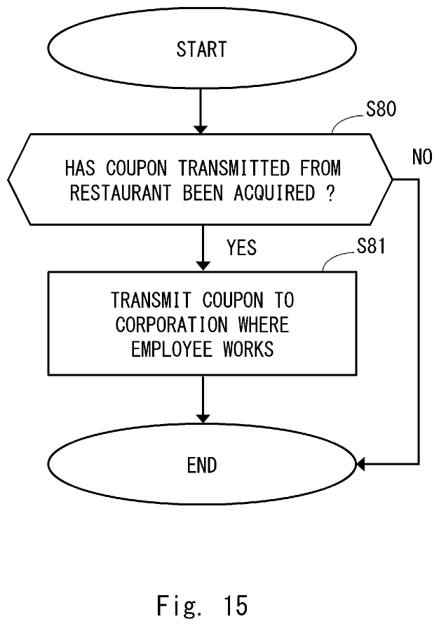

FIG. 15 is a flowchart of an example of operations performed by the coupon acquisition means 12h and the coupon providing means 12j.

As shown in FIG. 15, when the coupon acquisition means 12h acquires a coupon transmitted from the restaurant (the second information processing apparatus 30) that has received the matching result (Step S80: Yes), the coupon providing means 12j transmits the coupon to the corporation where the employee who has been matched to (i.e., paired with) the restaurant that has transmitted the coupon works (Step S81).

For example, when the coupon acquisition means 12h acquires a coupon transmitted from the restaurant A (the second information processing apparatus which has received the matching result (Step S80: Yes), the coupon providing means 12j transmits the coupon to the corporation (a company F in FIG. 5) where the employee who has been matched to (i.e., paired with) the restaurant A which has transmitted the coupon (i.e., the employee having the user ID “z”) works (Step S81).

Further, when the coupon acquisition means 12h acquires a coupon transmitted from the restaurant C (the second information processing apparatus which has received the matching result (Step S80: Yes), the coupon providing means 12j transmits the coupon to the corporation (a company D in FIG. 5) where the employee who has been matched to (i.e., paired with) the restaurant C which has transmitted the coupon (i.e., the employee having the user ID “x”) works (Step S81).

<Operation Example of Use Record Acquisition Means 12k and Use Record Reporting Means 12m>

The use record acquisition means 12k acquires, through the communication unit 14, a record of use of the restaurant that has transmitted the coupon, transmitted from that restaurant (i.e., from the second information processing apparatus 30) through the network NW. The use record reporting means 12m transmits, through the communication unit 14, the record of use of the restaurant acquired by the use record acquisition means 12k to the corporation where the employee, who has been matched to (i.e., paired with) the restaurant that has transmitted the record of use and has used that restaurant while presenting (i.e., using) the coupon, works.

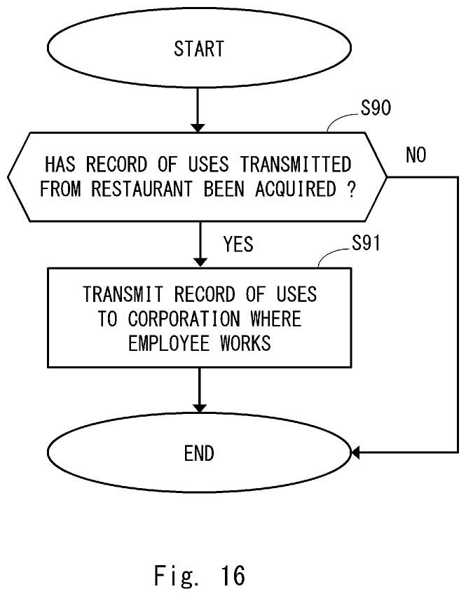

FIG. 16 is a flowchart of an example of operations performed by the use record acquisition means 12k and the use record reporting means 12m.

As shown in FIG. 16, when the use record acquisition means 12k acquires the record of use of the restaurant that has transmitted the coupon, transmitted from that restaurant (i.e., from the second information processing apparatus 30) (Step S90: Yes), the use record reporting means 12m transmits, through the communication unit 14, the acquired record of use to the corporation where the employee, who has been matched to (i.e., paired with) the restaurant that has transmitted the record of use and has used that restaurant while presenting the coupon, works (Step S91).

For example, when the use record acquisition means 12k acquires the record of use of the restaurant A which has transmitted the coupon (e.g., acquires the user ID “z” of the employee who has used the restaurant A while presenting the coupon, and points he/she has used), transmitted from that restaurant A (i.e., from the second information processing apparatus 30) (Step S90: Yes), the use record reporting means 12m transmits, through the communication unit 14, the record of use to the corporation (the company F, see FIG. 5) where the employee (the employee having the user ID “z”), who has been matched to (i.e., paired with) the restaurant A which has transmitted the record of use and has used that restaurant A while presenting the coupon, works (Step S91).

Further, when the use record acquisition means 12k acquires the record of use of the restaurant C which has transmitted the coupon (e.g., acquires the user ID “x” of the employee who has used the restaurant C while presenting the coupon, and points he/she has used), transmitted from that restaurant C (i.e., from the second information processing apparatus 30) (Step S90: Yes), the use record reporting means 12m transmits, through the communication unit 14, the record of use to the corporation (the company D, see FIG. 5) where the employee (the employee having the user ID “z”), who has been matched to (i.e., paired with) the restaurant C which has transmitted the record of use and has used that restaurant C while presenting the coupon, works (Step S91).

The communication unit 14 is a communication apparatus that communicates with the first information processing apparatus 20 and the second information processing apparatus 30 through the network NW (e.g., the Internet).

### <Configuration Example of First Information Processing Apparatus 20>

Next, an example of a configuration of the first information processing apparatus 20 will be described.

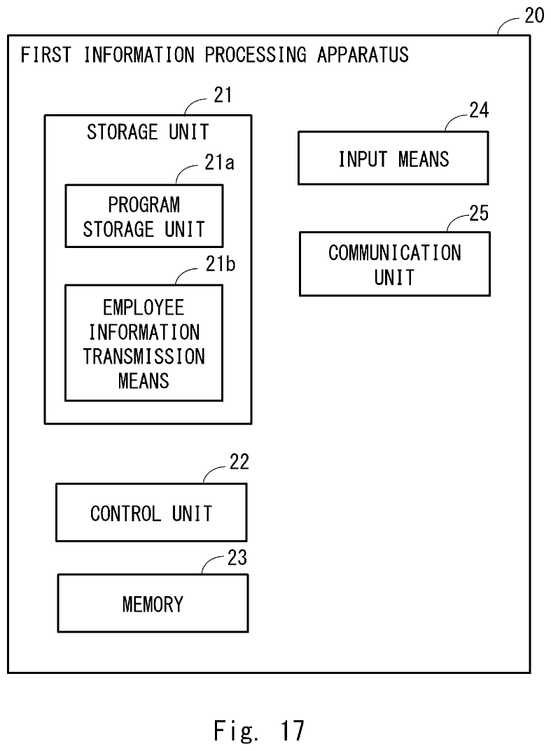

FIG. 17 is a configuration diagram of the first information processing apparatus 20.

The first information processing apparatus 20 is, for example, an information processing apparatus such as a personal computer or a server apparatus. The server apparatus may be a physical server or a virtual server on the network NW. As shown in FIG. 17, the first information processing apparatus 20 includes a storage unit 21, a control unit 22, a memory 23, input means 24, and a communication unit 25.

The storage unit 21 is, for example, a nonvolatile storage unit such as a hard disk drive or a ROM (Read Only Memory). The storage unit 21 includes a program storage unit 21a.

A program(s) executed by the control unit 22 (a processor) is stored in the program storage unit 21a.

The control unit 22 includes a processor (not shown). The processor is, for example, a CPU (Central Processing Unit). The processor may be one processor or may be composed of a plurality of processors. The processor functions as employee information transmission means 21b by executing a program loaded from the storage unit 21 (the program storage unit 21a) onto the memory 23 (e.g., a RAM (Random Access Memory)). It may be implemented by hardware.

The employee information transmission means 21b transmits employee information of an employee entered from the input means 24 to the data distribution platform 10 through the communication unit 25. The employee information includes a user ID, a workplace, and schedule information (a scheduled workplace-leaving time).

The input means 24 is, for example, an input device such as a keyboard and a mouse. The input means 24 is used, for example, to enter employee information of an employee. The employee information is entered by an employee or the like from the input means 24.

The communication unit 25 is a communication apparatus that communicates with the data distribution platform 10 through the network NW (e.g., the Internet).

### <Configuration Example of Second Information Processing Apparatus 30>

Next, an example of a configuration of the second information processing apparatus 30 will be described.

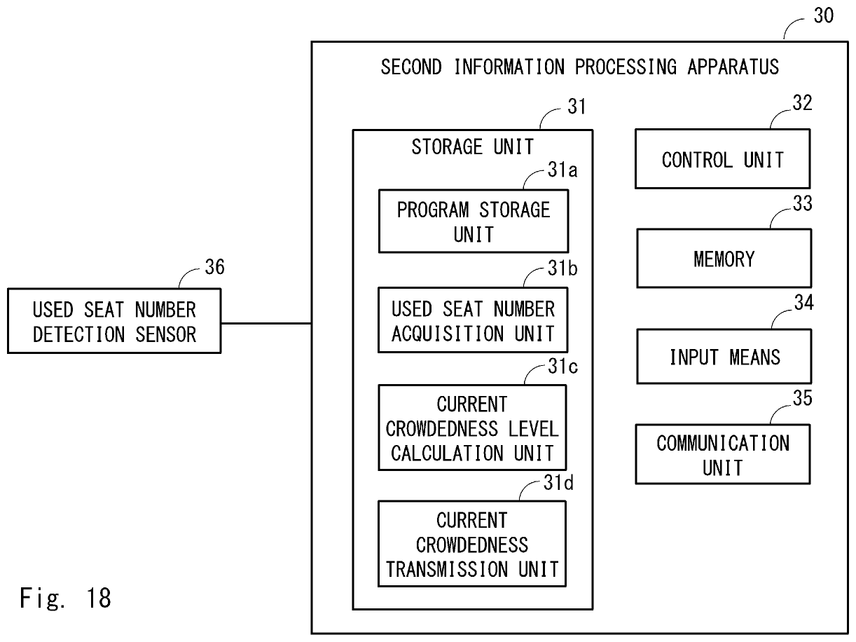

FIG. 18 is a configuration diagram of the second information processing apparatus 30.

The second information processing apparatus 30 is, for example, an information processing apparatus such as a personal computer or a server apparatus. The server apparatus may be a physical server or a virtual server on the network NW. As shown in FIG. 18, the second information processing apparatus 30 includes a storage unit 31, a control unit 32, a memory 33, input means 34, and a communication unit 35. Further, a used-seat number detection sensor 36 is electrically connected to the second information processing apparatus 30.

The storage unit 31 is, for example, a nonvolatile storage unit such as a hard disk drive or a ROM (Read Only Memory). The storage unit 31 includes a program storage unit 31a.

A program(s) executed by the control unit 32 (a processor) is stored in the program storage unit 31a.

The control unit 32 includes a processor (not shown). The processor is, for example, a CPU (Central Processing Unit). The processor may be one processor or may be composed of a plurality of processors. The processor functions as a used-seat number acquisition unit 31b, a current crowdedness level calculation unit 31c, and a store information transmission unit 31d by executing a program(s) loaded from the storage unit 31 (the program storage unit 31a) onto the memory 33 (e.g., a RAM (Random Access Memory)). Some or all of them may be implemented by hardware.

The used-seat number acquisition unit 31b acquires, from the used-seat number detection sensor 36, the number of currently used seats detected by the used-seat number detection sensor 36.

The current crowdedness level calculation unit 31c calculates a current crowdedness level based on the number of currently used seats acquired by the used-seat number acquisition unit 31b. The current crowdedness level is calculated, for example, by dividing the number of currently used seats by the total number of seats. Note that the total number of seats is stored, for example, in the storage unit 31 in advance.

The store information transmission unit 31d transmits the current crowdedness level calculated by the current crowdedness level calculation unit 31c to the data distribution platform 10 through communication unit 35. The store information includes a store name, a current crowdedness level, and a target crowdedness level.

The input means 34 is, for example, an input device such as a keyboard and a mouse. The input means 34 is used, for example, to enter a store name and a target crowdedness level. The store name and the target crowdedness level are entered by an employee or the like from the input means 24. The target crowdedness level may or may not be a target crowdedness level for each time period. For example, in the case of a small store, a target crowdedness level that is entered when the store is opened may be used throughout the day. In contrast, in the case of a large store, a target crowdedness level may be entered in real time and the entered target crowdedness level may be used as a resultant target crowdedness level value for each time period. Further, the target crowdedness level may be entered only once a day or a plurality of times a day.

The communication unit 35 is a communication apparatus that communicates with the data distribution platform 10 through the network NW (e.g., the Internet).

The used-seat number detection sensor 36 is provided in each restaurant and detects the number of currently used seats in that restaurant. The used-seat number detection sensor 36 includes, for example, a photographing device that photographs the inside of the restaurant, and detects the number of currently used seats by performing predetermined image processing on the image taken by the photographing device. Alternatively, the used-seat number detection sensor 36 may be a proximity sensor or any of other types of sensors that is provided in each seat in the restaurant and detects the presence/absence of a person for the like on that seat.

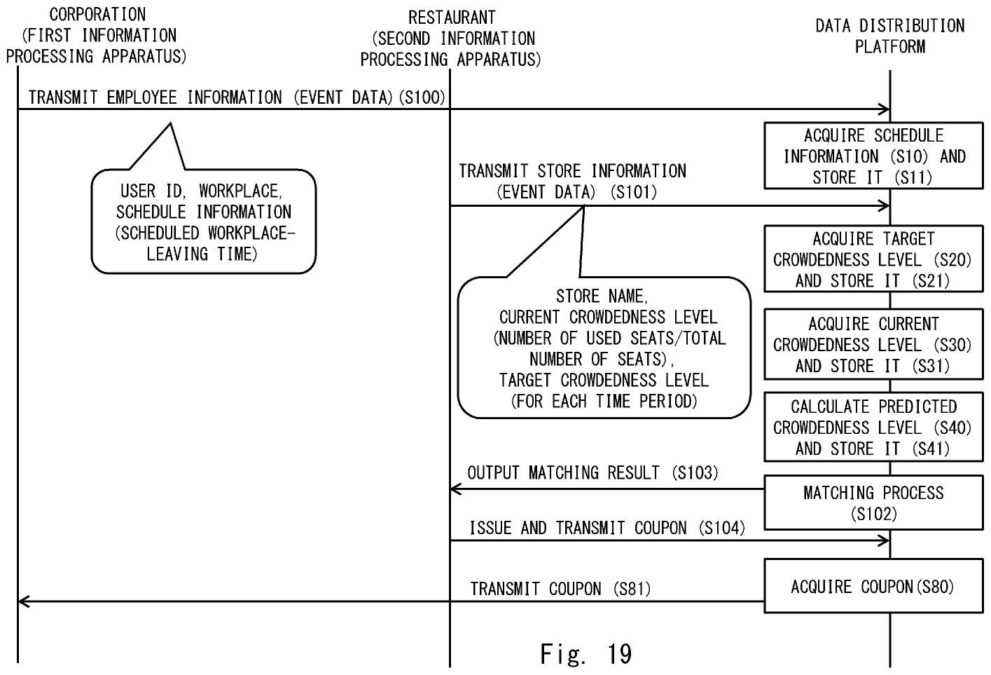

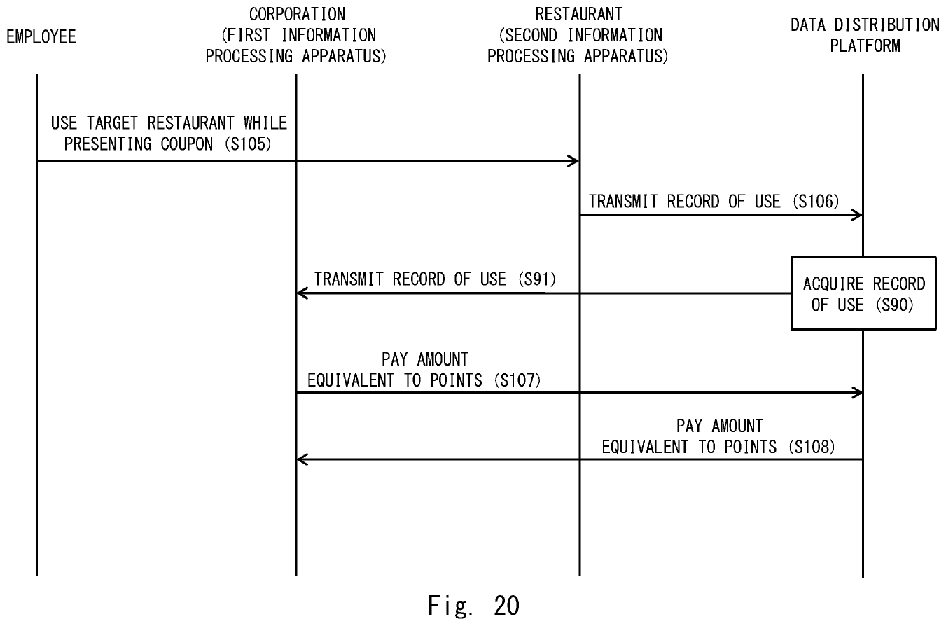

Next, an example of operations performed by the information processing system 1 will be described with reference to FIGS. 19 and 20.

FIGS. 19 and 20 are sequence diagrams of an example of operations performed by the information processing system 1.

Firstly, each corporation (the first information processing apparatus 20) transmits event data (hereafter referred to as employee information) to the data distribution platform 10 (S100). The employee information includes, for example, a user ID, a workplace, and schedule information (e.g., a scheduled workplace-leaving time). The schedule information may include additional information indicating that there is room for an adjustment before or after the scheduled time. Note that the degree of details of the employee information is limited by the information protection policy of the corporation that transmits the employee information. In general, employee numbers and email addresses of employees cannot be transmitted. The employee information may be transmitted from the corporation (the first information processing apparatus 20) to the data distribution platform 10 at any time. For example, the employee information is transmitted from the corporation (the first information processing apparatus 20) to the data distribution platform 10 at regular intervals (e.g., every 30 minutes), or every time employee information is entered from the input means 24.

The employee information acquisition means 12a of the data distribution platform 10 acquires the employee information transmitted from the corporation (the first information processing apparatus 20) (Step S10 in FIG. 8: Yes), and the acquired employee information is stored in the employee information storage unit 11b (Step S11 in FIG. 8).

Next, a restaurant (the second information processing apparatus 30) transmits event data (hereafter referred to as store information) to the data distribution platform 10 (S101). The store information includes, for example, a store name, a current crowdedness level ([Number of currently used seats]/[Total number of seats]), and a target crowdedness level. Note that the input of the target crowdedness level may be omitted. In such a case, the store information includes information items other than the target crowdedness level, i.e., includes, for example, a store name and a current crowdedness level ([Number of currently used seats]/[Total number of seats]). Note that the degree of details of the store information is limited by the information protection policy of the restaurant that transmits the store information. In general, information about costs and cost rates of restaurants cannot be transmitted. The store information is transmitted to the data distribution platform 10 at regular intervals (e.g., every 30 minutes), every time a target crowdedness level is entered from the input means 34, or every time the used-seat number acquisition unit 31b acquires the number of currently used seats detected by the used-seat number detection sensor 36 from the used-seat number detection sensor 36.

The target crowdedness level acquisition means 12b of the data distribution platform 10 acquires the target crowdedness level contained in the store information transmitted from the restaurant (the second information processing apparatus 30) (Step S20 in FIG. 9: Yes), and the acquired target crowdedness level is stored in the store information storage unit 11c (Step S21 in FIG. 9). Note that when the store information transmitted from the restaurant (the second information processing apparatus 30) does not contain the target crowdedness level (when the target crowdedness level is omitted), a target crowdedness level that is set as an initial value is stored in the store information storage unit 11c.

Further, the current crowdedness level acquisition means 12c of the data distribution platform 10 acquires the current crowdedness level contained in the store information transmitted from the restaurant (the second information processing apparatus 30) (Step S30 in FIG. 10: Yes), and the acquired current crowdedness level contained is accumulated (stored) in the crowdedness level accumulation unit 11d (Step S31 in FIG. 10).

Next, the predicted crowdedness level calculation means 12d of the data distribution platform 10 calculates a predicted crowdedness level of each restaurant (Step S40 in FIG. 11). For example, the predicted crowdedness level calculation means 12d calculates a predicted crowdedness level for each time period during business hours of the day (i.e., each of time periods from the opening of the restaurant to the closing thereof). This calculated predicted crowdedness level is stored in the store information storage unit 11c (Step S41).

Next, the data distribution platform 10 performs a matching process (Step S102). The matching process (a matching process procedure) may be registered, for example, in an event catalog (not shown). The event catalog is stored, for example, in the storage unit 11 of the data distribution platform 10. One matching process (one matching process procedure) registered in the event catalog will be described hereinafter.

The matching process (the matching process procedure) includes a process for extracting, from the store information storage unit 11c, a restaurant for which there is a time period during which the predicted crowdedness level is lower than the target crowdedness level as a restaurant to which a customer should be sent (see FIG. 12), a process for extracting, from the employee information storage unit 11b, an employee who can use the restaurant for which there is the time period during which the predicted crowdedness level is lower than the target crowdedness level in this time period (see FIG. 13), and a process for outputting a combination of the extracted restaurant and the extracted employee as a matching result (see FIG. 14).

An example case where a restaurant A for which there is a time period during which the predicted crowdedness level is lower than the target crowdedness level (i.e., a time period from 19:00 to 21:00) is extracted as a restaurant to which a customer should be sent, and an employee having a user ID “z” whose scheduled workplace-leaving time is within or close to this time period is extracted as an employee who can use the restaurant A in the aforementioned time period (i.e., the time period from 19:00 to 21:00) will be described hereinafter. Note that it is assumed that the employee having the user ID “z” has received welfare points (hereinafter referred to simply as points) in advance from the corporation where the employee works.

In this case, the output means 12g of the data distribution platform 10 transmits the user ID “z” to the restaurant A as a matching result (Step S103).

Next, the restaurant A, which has acquired (received) the matching result transmitted from the data distribution platform 10, issues a coupon for the employee having the user ID “z”, who has been matched to (i.e., paired with) the restaurant A based on the matching result, and transmits the issued coupon to the data distribution platform 10 (Step S104). The coupon includes the name of the restaurant, the time period, an item(s), and the target person, for example, in the form of “Restaurant name: Restaurant A, Time period: 19:00 to 21:00, Item: Beer at half price, Target: User z”.

Next, the coupon acquisition means 12h of the data distribution platform 10 acquires the coupon transmitted from the restaurant A (the second information processing apparatus 30) (Step S80: Yes). Then, the coupon providing means 12j of the data distribution platform 10 transmits the coupon to the corporation (“Company F” in this example, see FIG. 5) where the employee having the user ID “z”, who has been matched to (i.e., paired with) the restaurant A which has transmitted the coupon, works (Step S81). The corporation, which has received the coupon, refers to the corresponding relationship between user IDs and employee numbers (or email addresses), and forwards the coupon to the target person. Alternatively, coupons may be distributed to employees who want to get the coupons on a first-come-first-served basis.

Next, the employee, who has received the coupon, uses the target restaurant A (Step S105). For example, the employee, who has received the coupon, presents (i.e., shows) the coupon (e.g., displays the coupon information on his/her smartphone by using a smartphone application), and orders the item(s) (e.g., a food(s) or a drink(s)) at the target restaurant A. The employee can use points (welfare points) received from the corporation where he/she works for the payment.

Next, the restaurant A (the second information processing apparatus 30) transmits the record of use (e.g., the user ID “z” of the employee who has used the restaurant A, and points he/she has used) to the data distribution platform 10 (Step S106).

Next, the use record acquisition means 12k of the data distribution platform 10 acquires the record of use transmitted from the restaurant A (the second information processing apparatus 30) (Step S90). Then, the use record reporting means 12m of the data distribution platform 10 informs the corporation (“Company F” in this example, see FIG. 5), where the employee having the user ID “z” matched to (i.e., paired with) the restaurant A which has transmitted the record of use works, of the record of use (i.e., transmits the record of use to the corporation) (Step S91).

Next, the corporation, which has received the information about the record of use, pays an amount equivalent to the points to the data distribution platform (the building management company) (Step S107).

Next, the data distribution platform 10 (the building management company), which has received the payment, pays the amount equivalent to the points to the restaurant tenant (Step S108).

As described above, according to the second example embodiment, it is possible to increase sales of restaurant tenants and satisfaction of employees of corporate tenants.

This is because the output means 12g outputs a combination of a restaurant extracted by the restaurant extraction means 12e (a restaurant of which the predicted crowdedness level is lower than the target crowdedness level) and an employee who can use this restaurant as a matching result.

Next, a modified example will be described.

In the above-described second example embodiment, as shown in FIGS. 3 and 19, an example in which the employee information that the corporation (the first information processing apparatus 20) transmits to the data distribution platform 10 includes a user ID, a workplace, and schedule information (a scheduled workplace-leaving time) has been described. However, the present disclosure is not limited to this example. For example, the employee information may also include preference information in addition to the above-described information items. The preference information may include, for example, a preference, a calorie restriction, a salt restriction, and un-recommended items.

Further, in the above-described second example embodiment, as shown in FIG. 19, an example in which the store information that the restaurant (the second information processing apparatus 30) transmits to the data distribution platform 10 includes a store name, a current crowdedness level ([Number of currently used seats]/[Total number of seats]), and a target crowdedness level has been described. However, the present disclosure is not limited to this example. For example, the store information may also include menu information in addition to the above-described information items. The menu information may include, for example, a name of a dish, a price, ingredients, calories, and an amount of salt.

Further, in the above-described second example embodiment, an example in which the output means 12g outputs a combination of a restaurant for which there is a time period during which the predicted crowdedness level is lower than the target crowdedness level, extracted by the restaurant extraction means 12e and an employee who can use the restaurant in this time period, extracted by the employee extraction means 12f as a matching result has been described. However, the present disclosure is not limited to this example. For example, the output means 12g may output a matching result while also taking preference information of the employee into consideration. For example, the output means 12g may also output (e.g., transmits through the communication unit 14) a combination of a restaurant and an employee in which the preference information of the employee and the conditions of the menu information of the restaurant coincide with each other as a matching result.

Note that when information indicating that there is room for an adjustment is added in the schedule information, time periods before and after the scheduled workplace-leaving time and the scheduled break may also be included in the time period based of which the matching is made. In this case, the priority of the above-described matching is preferably made lower than that of the matching that is made based on the original scheduled workplace-leaving time and the original scheduled break.

Note that the target crowdedness level may be output in some stores and may not be output in other stores. When the target crowdedness level is not output, the value of the target crowdedness level that is set as the initial value may continue to be used, or a store of which the crowdedness level is lower than the predicted crowdedness level may be extracted as a restaurant to which a customer(s) should be sent based on the predicted crowdedness level.

That is, when the data distribution platform 10 acquires a target crowdedness level value from a store once or several times, it(they) may be divided into corresponding time periods and they may be treated as target crowdedness levels for the respective time periods, or the comparison with the predicted crowdedness level may be performed by using the target crowdedness level that is acquired most recently.

In the above-described first and second embodiments, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, and RAM (Random Access Memory)). Further, the program may be provided to a computer using any type of transitory computer readable media. Examples of transitory computer readable media include electric signals, optical signals, and electromagnetic waves. Transitory computer readable media can provide the program to a computer through a wired communication line (e.g., electric wires, and optical fibers) or a wireless communication line.

The whole or part of the example embodiments disclosed above can be described as, but not limited to, the following supplementary notes.

### (Supplementary Note 1)

A data distribution platform comprising:
employee information acquisition means for acquiring employee information of an employee;
target crowdedness level acquisition means for acquiring a target crowdedness level of a restaurant;
predicted crowdedness level calculation means for calculating a predicted crowdedness level of each restaurant;
employee information storage means in which the employee information of each employee is stored;
store information storage means in which the predicted crowdedness level and the target crowdedness level of each restaurant are stored;
restaurant extraction means for extracting, from the store information storage means, a restaurant of which the predicted crowdedness level is lower than the target crowdedness level as a restaurant to which a customer should be sent;
employee extraction means for extracting, from the employee information storage means, an employee who can use the restaurant extracted by the restaurant extraction means as an employee to be induced to go to the restaurant; and
output means for outputting a combination of the restaurant extracted by the restaurant extraction means and the employee who can use the restaurant as a matching result.

### (Supplementary Note 2)

The data distribution platform described in Supplementary note 1, wherein
the target crowdedness level is a target crowdedness level for each time period,
the predicted crowdedness level is a predicted crowdedness level for each time period, and
the employee extraction means extracts, from the employee information storage means, an employee who can use a restaurant for which there is a time period during which the predicted crowdedness level is lower than the target crowdedness level in that time period as an employee to be induced to go to the restaurant.

### (Supplementary Note 3)

The data distribution platform described in Supplementary note 2, wherein an employee who can use a restaurant for which there is a time period during which the predicted crowdedness level is lower than the target crowdedness level in that time period is an employee whose scheduled workplace-leaving time is within or close to the time period during which the predicted crowdedness level is lower than the target crowdedness level in that time period.

### (Supplementary Note 4)

The data distribution platform described in Supplementary note 2 or 3, wherein an employee who can use a restaurant for which there is a time period during which the predicted crowdedness level is lower than the target crowdedness level in that time period is an employee whose scheduled break time is within or close to the time period during which the predicted crowdedness level is lower than the target crowdedness level in that time period.

### (Supplementary Note 5)

The data distribution platform described in any one of Supplementary notes 1 to 4, further comprising:
crowdedness level accumulation means in which a crowdedness level of each restaurant is accumulated; and
current crowdedness level acquisition means for acquiring a current crowdedness level of a restaurant, wherein
the current crowdedness level is accumulated in the crowdedness level accumulation means, and
the predicted crowdedness level calculation means calculates the predicted crowdedness level based on the crowdedness level accumulated in the crowdedness level accumulation means.

### (Supplementary Note 6)

The data distribution platform described in any one of Supplementary notes 1 to 5, wherein the output means outputs the matching result while taking preference information of the employee who can use the restaurant into consideration.

### (Supplementary Note 7)

The data distribution platform described in any one of Supplementary notes 1 to 6, further comprising:
coupon acquisition means for acquiring a coupon transmitted from a restaurant that has received the matching result, and
coupon providing means for transmitting the coupon acquired by the coupon acquisition means to a corporation where the employee who has been matched to the restaurant that has transmitted the coupon works.

### (Supplementary Note 8)

The data distribution platform described in any one of Supplementary notes 1 to 7, further comprising:
use record acquisition means for acquiring a record of use of the restaurant that has transmitted the coupon from that restaurant, and
use record reporting means for transmitting the record of use of the restaurant acquired by the use record acquisition means to a corporation where the employee, who has been matched to the restaurant that has transmitted the record of use and has used that restaurant while presenting the coupon, works.

### (Supplementary Note 9)

An information processing system comprising:
a first information processing apparatus; and
a second information processing apparatus; and
a data distribution platform, wherein
the data distribution platform includes:
employee information acquisition means for acquiring employee information of an employee transmitted from the first information processing apparatus;
target crowdedness level acquisition means for acquiring a target crowdedness level of a restaurant transmitted from the second information processing apparatus;
predicted crowdedness level calculation means for calculating a predicted crowdedness level of each restaurant;
employee information storage means in which the employee information of each employee is stored;
store information storage means in which the predicted crowdedness level and the target crowdedness level of each restaurant are stored;
restaurant extraction means for extracting, from the store information storage means, a restaurant of which the predicted crowdedness level is lower than the target crowdedness level as a restaurant to which a customer should be sent;
employee extraction means for extracting, from the employee information storage means, an employee who can go to the restaurant extracted by the restaurant extraction means as an employee to be induced to go to the restaurant; and
output means for outputting a combination of the restaurant extracted by the restaurant extraction means and the employee extracted by the employee extraction means as a matching result.

### (Supplementary Note 10)

An information processing method comprising:
an employee information acquisition step of acquiring employee information of an employee;
a target crowdedness level acquisition step of acquiring a target crowdedness level of a restaurant;
a predicted crowdedness level calculation step of calculating a predicted crowdedness level of each restaurant;
a restaurant extraction step of extracting, from store information storage means, a restaurant of which the predicted crowdedness level is lower than the target crowdedness level as a restaurant to which a customer should be sent, the store information storage means storing therein the predicted crowdedness level and the target crowdedness level of each restaurant;
an employee extraction step of extracting, from employee information storage means, an employee who can go to the restaurant extracted in the restaurant extraction step as an employee to be induced to go to the restaurant, the employee information storage means storing therein the employee information of each employee; and
an output step of outputting a combination of the restaurant extracted in the restaurant extraction step and the employee extracted in the employee extraction step as a matching result.

### (Supplementary Note 11)

A computer readable recording medium storing a program for causing a computer to perform:
an employee information acquisition step of acquiring employee information of an employee;
a target crowdedness level acquisition step of acquiring a target crowdedness level of a restaurant;
a predicted crowdedness level calculation step of calculating a predicted crowdedness level of each restaurant;
a restaurant extraction step of extracting, from store information storage means, a restaurant of which the predicted crowdedness level is lower than the target crowdedness level as a restaurant to which a customer should be sent, the store information storage means storing therein the predicted crowdedness level and the target crowdedness level of each restaurant;
an employee extraction step of extracting, from employee information storage means, an employee who can go to the restaurant extracted in the restaurant extraction step as an employee to be induced to go to the restaurant, the employee information storage means storing therein the employee information of each employee; and
an output step of outputting a combination of the restaurant extracted in the restaurant extraction step and the employee extracted in the employee extraction step as a matching result.

All the numeral values mentioned in the above-described example embodiments are merely examples, and needless to say, numeral values different from them can be uses as desired.

The above-described example embodiments are merely examples in all the aspects thereof.

The present invention should not be limited by the descriptions of the above-described example embodiments.

The present invention may be carried out in various other forms without departing from the spirit or main features of the invention.

### REFERENCE SIGNS LIST

1 INFORMATION PROCESSING SYSTEM
10 DATA DISTRIBUTION PLATFORM
11 STORAGE UNIT
11a PROGRAM STORAGE UNIT
11b EMPLOYEE INFORMATION STORAGE UNIT (EMPLOYEE INFORMATION STORAGE MEANS)
11c STORE INFORMATION STORAGE UNIT (STORE INFORMATION STORAGE MEANS)
11d CROWDEDNESS LEVEL ACCUMULATION UNIT
11e EVENT CATALOG STORAGE UNIT
12 CONTROL UNIT
12a EMPLOYEE INFORMATION ACQUISITION MEANS
12b TARGET CROWDEDNESS LEVEL ACQUISITION MEANS
12c CURRENT CROWDEDNESS LEVEL ACQUISITION MEANS
12d PREDICTED CROWDEDNESS LEVEL CALCULATION MEANS
12e RESTAURANT EXTRACTION MEANS
12f EMPLOYEE EXTRACTION MEANS
12g OUTPUT MEANS
12h COUPON ACQUISITION MEANS
12j COUPON PROVIDING MEANS
12k USE RECORD ACQUISITION MEANS
12m USE RECORD REPORTING MEANS
13 MEMORY
14 COMMUNICATION UNIT
20 FIRST INFORMATION PROCESSING APPARATUS
21 STORAGE UNIT
21a PROGRAM STORAGE UNIT
21b EMPLOYEE INFORMATION TRANSMISSION MEANS
22 CONTROL UNIT
23 MEMORY
24 INPUT MEANS
25 COMMUNICATION UNIT
30 SECOND INFORMATION PROCESSING APPARATUS
31 STORAGE UNIT
31a PROGRAM STORAGE UNIT
31b USED SEAT NUMBER ACQUISITION UNIT
31c CURRENT CROWDEDNESS LEVEL CALCULATION UNIT
31d CURRENT CROWDEDNESS TRANSMISSION UNIT
32 CONTROL UNIT
33 MEMORY
34 INPUT MEANS
35 COMMUNICATION UNIT
36 USED SEAT NUMBER DETECTION SENSOR
NW NETWORK

What is claimed is:

1. A data distribution platform comprising:
hardware, including a processor and memory;
employee information acquisition unit implemented at least by the hardware and configured to acquire employee information of an employee;
target crowdedness level acquisition unit implemented at least by the hardware and configured to acquire a target crowdedness level of a restaurant;
predicted crowdedness level calculation unit implemented at least by the hardware and configured to calculate a predicted crowdedness level of each restaurant;
employee information storage unit in which the employee information of each employee is stored;
store information storage unit in which the predicted crowdedness level and the target crowdedness level of each restaurant are stored;
restaurant extraction unit implemented at least by the hardware and configured to extract, from the store information storage mean& unit, a restaurant of which the predicted crowdedness level is lower than the target crowdedness level as a restaurant to which a customer should be sent;
employee extraction unit implemented at least by the hardware and configured to extract, from the employee information storage m an; unit, an employee who can use the restaurant extracted by the restaurant extraction unit as an employee to be induced to go to the restaurant; and
output unit implemented at least by the hardware and configured to output a combination of the restaurant extracted by the restaurant extraction unit and the employee who can use the restaurant as a matching result.

2. The data distribution platform according to claim 1, wherein
the target crowdedness level is a target crowdedness level for each time period,
the predicted crowdedness level is a predicted crowdedness level for each time period, and
the employee extraction unit extracts, from the employee information storage unit, an employee who can use a restaurant for which there is a time period during which the predicted crowdedness level is lower than the target crowdedness level in that time period as an employee to be induced to go to the restaurant.

3. The data distribution platform according to claim 2, wherein an employee who can use a restaurant for which there is a time period during which the predicted crowdedness level is lower than the target crowdedness level in that time period is an employee whose scheduled workplace-leaving time is within or close to the time period during which the predicted crowdedness level is lower than the target crowdedness level in that time period.

4. The data distribution platform according to claim 2, wherein an employee who can use a restaurant for which there is a time period during which the predicted crowdedness level is lower than the target crowdedness level in that time period is an employee whose scheduled break time is within or close to the time period during which the predicted crowdedness level is lower than the target crowdedness level in that time period.

5. The data distribution platform according to claim 1, further comprising:
crowdedness level accumulation unit in which a crowdedness level of each restaurant is accumulated; and
current crowdedness level acquisition unit implemented at least by the hardware and configured to acquire a current crowdedness level of a restaurant, wherein
the current crowdedness level is accumulated in the crowdedness level accumulation unit, and
the predicted crowdedness level calculation unit calculates the predicted crowdedness level based on the crowdedness level accumulated in the crowdedness level accumulation unit.

6. The data distribution platform according to claim 1, wherein the output unit outputs the matching result while taking preference information of the employee who can use the restaurant into consideration.

7. The data distribution platform according to claim 1, further comprising:
coupon acquisition unit implemented at least by the hardware and configured to acquire a coupon transmitted from a restaurant that has received the matching result, and
coupon providing unit implemented at least by the hardware and configured to transmit the coupon acquired by the coupon acquisition unit to a corporation where the employee who has been matched to the restaurant that has transmitted the coupon works.

8. The data distribution platform according to claim 1, further comprising:
use record acquisition unit implemented at least by the hardware and configured to acquire a record of use of the restaurant that has transmitted the coupon from that restaurant, and
use record reporting unit implemented at least by the hardware and configured to transmit the record of use of the restaurant acquired by the use record acquisition unit to a corporation where the employee, who has been matched to the restaurant that has transmitted the record of use and has used that restaurant while presenting the coupon, works.

9. (canceled)

10. An information processing method comprising:
an employee information acquisition step of acquiring employee information of an employee;
a target crowdedness level acquisition step of acquiring a target crowdedness level of a restaurant;
a predicted crowdedness level calculation step of calculating a predicted crowdedness level of each restaurant;
a restaurant extraction step of extracting, from store information storage unit, a restaurant of which the predicted crowdedness level is lower than the target crowdedness level as a restaurant to which a customer should be sent, the store information storage unit storing therein the predicted crowdedness level and the target crowdedness level of each restaurant;
an employee extraction step of extracting, from employee information storage unit, an employee who can go to the restaurant extracted in the restaurant extraction step as an employee to be induced to go to the restaurant, the employee information storage unit storing therein the employee information of each employee; and
an output step of outputting a combination of the restaurant extracted in the restaurant extraction step and the employee extracted in the employee extraction step as a matching result.

11. A computer readable recording medium storing a program for causing a computer to perform:
an employee information acquisition step of acquiring employee information of an employee;
a target crowdedness level acquisition step of acquiring a target crowdedness level of a restaurant;
a predicted crowdedness level calculation step of calculating a predicted crowdedness level of each restaurant;
a restaurant extraction step of extracting, from store information storage unit, a restaurant of which the predicted crowdedness level is lower than the target crowdedness level as a restaurant to which a customer should be sent, the store information storage unit storing therein the predicted crowdedness level and the target crowdedness level of each restaurant;
an employee extraction step of extracting, from employee information storage unit, an employee who can go to the restaurant extracted in the restaurant extraction step as an employee to be induced to go to the restaurant, the employee information storage unit storing therein the employee information of each employee; and
an output step of outputting a combination of the restaurant extracted in the restaurant extraction step and the employee extracted in the employee extraction step as a matching result.
